(19) United States
(12) Patent Application Publication
(10) Pub. No.: US 2015/0356346 A1
(43) Pub. Date: Dec. 10, 2015

(54) FEATURE POINT POSITION DETECTING APPARARUS, FEATURE POINT POSITION DETECTING METHOD AND FEATURE POINT POSITION DETECTING PROGRAM

(71) Applicant: NEC CORPORATION, Minato-ku, Tokyo (JP)

(72) Inventor: Yusuke MORISHITA, Tokyo (JP)

(73) Assignee: NEC Corporation, Minato-ku, Tokyo (JP)

(21) Appl. No.: 14/759,155

(22) PCT Filed: Jan. 14, 2014
(86) PCT No.: PCT/JP2014/000102

§ 371 Date: Jul. 2, 2015

(30) Foreign Application Priority Data
Jan. 15, 2013 (JP) 2013-004228

(51) Int. Cl. G06K 9/00; G06T 7/60; G06T 7/00

(52) U.S. Cl. CPC G06K 9/00248; G06T 7/0044; G06T 7/0048; G06T 7/602; G06T 2207/30201

(57) ABSTRACT

A feature point position detecting apparatus according to the present invention detects a position of a feature point of an target image by: inputting initial information on the feature point position, which is provided from the outside, according to the target image; estimating feature point estimation positions, whose number is requested, in the target image on the basis of the feature point position initial information and feature point position estimation dictionary information; finding a search parameter, which is used for searching the feature point position of the target image, on the basis of the feature point estimation position; and carrying out parameter fitting to a model of the target image on the basis of the search parameter.

### TECHNICAL FIELD

The present invention relates to a feature point position detecting art which is used for detecting a position of a feature point such as an eye, a nose or the like from a face image or the like.

### BACKGROUND ART

Feature point position detection, which means to detect a position of a feature point of an organ such as an eye, a nose, a mouth or the like from a face image or the like, becomes important for carrying out the face authentication, the facial expression recognition or the like with high level accuracy.

As the art which detects the feature point position of the face, for example, Active Appearance Mode (AAM) is known (NPL 1). According to AAM, on the basis of a plurality of face images and information on positions of feature points which are inputted onto the plural face images in advance, a model which relates to a texture and a shape of a face is constructed with a statistical method, and the model is fitted to an image including a face which is a detection target. Then, by updating parameters of the model repeatedly so that a face image, which is calculated from the model, may approach the face image of the detection target, the feature point position is detected. After AAM is proposed, AAM is extended variously. For example, a method of combining a plurality of models in order to cope with detection of a side face, or improvement for realizing a high speed process and a high level accurate process is proposed.

Meanwhile, it is known that AAM severely suffers from influence of an initial value (initial parameter) which is used when carrying out fitting to the model. To cope with the problem, for example, NPL 2 improves performance of detecting the feature point position through estimating a parameter of AAM by use of a cylinder head model, and PTL 1 provides a distinction method which is robust against a change in a direction of face by rotating a face image in order to cope with the change in the direction of face.

### CITATION LIST

### Patent Literature

[PTL 1] Japanese Patent Application Laid-Open Publication NO. 2009-157767

### Non Patent Literature

[NPL 1] T. F. Cootes, G. J. Edwards and C. J. Taylor. ‘Active Appearance Models’, IEEE PAMI, Vol. 23, No. 6, pp. 681-685, 2001.
[NPL 2] Jaewon Sung, et al., ‘Pose Robust Face Tracking by Combining Active Appearance Models and Cylinder Head Models,’ IJCV, 2008.
[NPL 3] D. Cristinacce and T. F. Cootes, ‘A comparison of Shape Constrained Facial Feature Detectors, ‘In 6^{th} International Conference on Automatic Face and Gesture Recognition 2004, Korea, pp 357-380, 2004.

### SUMMARY OF INVENTION

### Technical Problem

However, there is a problem that, for carrying out to fit AAM accurately to a face image which changes variously due to a change in a face expression, a personal face difference or a change in a posture, an amount of information becomes short even if using the head model as shown in NPL 2, or rotating the face image as shown in PTL 1. As a result, in the case that the change in the face expression, the personal face difference or the change in the posture is generated, a trouble that fitting of the model results in falling into the local optimum solution, and consequently it is difficult to detect the feature point position with high level accuracy.

The present invention is conceived in order to solve the above-mentioned problem. An object of the present invention is to make it possible to carry out high level accurate detection of the feature point position which can prevent fitting of the model from falling into the local optimum solution against the various changes generated in the face image or the like, which is a target, due to the change in the face expression, the personal face difference, the change in the posture or the like.

### Solution to Problem

A feature point position estimating apparatus according to the present invention includes: a feature point position initial information inputting means to input initial information on a position of a feature point, which is provided from the outside, according to a target image; a feature point estimation position estimating means to estimate feature point estimation positions, whose number is requested, in the target image on the basis of the feature point position initial information, and feature point position estimation dictionary information; a model parameter calculating means to find a search parameter, which is used for searching the feature point position of the target image, on the basis of the feature point estimation position; and a feature point position searching means to search and detect the feature point position of the target image by carrying out parameter fitting to a model of the target image on the basis of the search parameter.

A feature point position estimating method according to the present invention includes: inputting initial information on a position of a feature point, which is provided from the outside, according to a target image; estimating feature point estimation positions, whose number is requested, in the target image on the basis of the feature point position initial information and feature point position estimation dictionary information; finding a search parameter, which is used for searching the feature point position of the target image, on the basis of the feature point estimation position; and searching and detecting the feature point position of the target image by carrying out parameter fitting to a model of the target image on the basis of the search parameter.

A feature point position estimating program according to the present invention makes a feature point position detecting apparatus execute: a process of inputting initial information on a position of a feature point, which is provided from the outside, according to a target image; a process of estimating feature point estimation positions, whose number is requested, in the target image on the basis of the feature point position initial information and feature point position estimation dictionary information; a process of finding a search parameter, which is used for searching the feature point position of the target image, on the basis of the feature point estimation position; and a process of searching and detecting the feature point position of the target image by carrying out parameter fitting to a model of the target image on the basis of the search parameter.

### Advantageous Effects of Invention

According to the present invention, it is possible to carry out high level accurate detection of the feature point position which can prevent fitting of the model from falling into the local optimum solution against the various changes generated in the face image or the like, which is a target, due to the change in the face expression, the personal face difference, the change in the posture or the like.

### BRIEF DESCRIPTION OF DRAWINGS

FIG. 1 is a block diagram showing a configuration of a feature point position detecting apparatus of an exemplary embodiment of the present invention.

FIG. 2 is a flowchart showing an operation of the feature point position detecting apparatus of the exemplary embodiment of the present invention.

FIG. 3 is a diagram showing an example of a face image which is a target of a process carried out by the feature point position detecting apparatus of the exemplary embodiment of the present invention.

FIG. 4 is diagram showing an example of feature point position initial information which a feature point position initial information inputting means of the feature point position detecting apparatus of the exemplary embodiment of the present invention inputs.

FIG. 5 is diagram showing an example of a feature point estimation position which a feature point estimation position estimating means of the feature point position detecting apparatus of the exemplary embodiment of the present invention estimates.

### DESCRIPTION OF EMBODIMENTS

Hereinafter, the best exemplary embodiment of the present invention will be explained in detail with reference to a drawing. While the exemplary embodiment, which will be explained in the following, includes limitation which is preferable technically for carrying out the present invention, the scope of the invention is not limited to the following exemplary embodiment.

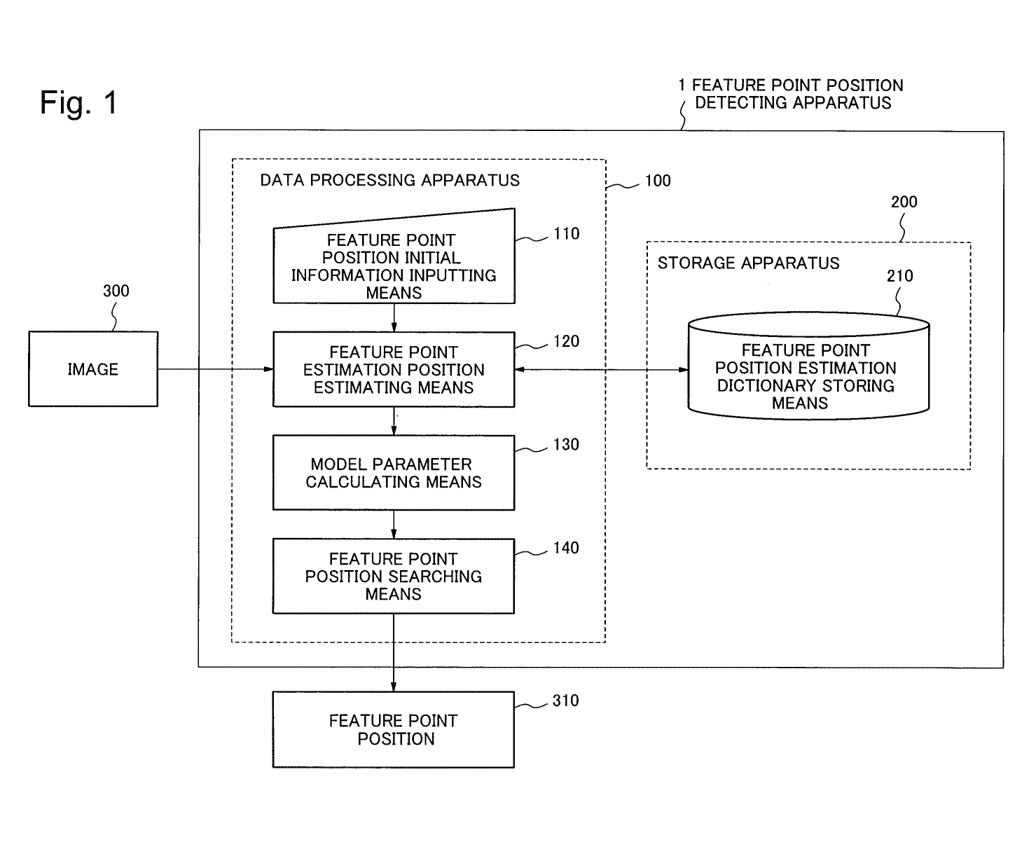

A feature point position detecting apparatus of the exemplary embodiment of the present invention will be explained in the following with reference to a drawing. FIG. 1 is a block diagram showing a configuration of a feature point position detecting apparatus 1 which detects a position of a feature point of a face image or the like according to the exemplary embodiment of the present invention.

As shown in FIG. 1, the feature point position detecting apparatus 1 of the present exemplary embodiment includes a data processing apparatus 100 and a storage apparatus 200. The data processing apparatus 100 includes a feature point position initial information inputting means 110 which inputs initial information on the feature point position of the face image or the like, a feature point estimation position estimating means 120 which estimates a feature point estimation position, a model parameter calculating means 130 and a facial feature point position searching means 140. The storage apparatus 200 includes a feature point position estimation dictionary storing means 210 storing a dictionary which is used for estimating the feature point position of the face image or the like.

The feature point position initial information inputting means 110 inputs the initial information on the feature point position, which is provided from the outside, according to an image 300 including the face mage or the like. The initial information on the feature point position is, for example, information on a feature point position of an eye, a nose, mouth or the like which is acquired by an external and optional apparatus working for detecting the feature point position. The feature point estimation position estimating means 120 estimates the feature point estimation positions, whose number is requested, in the target image 300 on the basis of the initial information on the feature point position, which is inputted by the feature point position initial information inputting means 110, with reference to the feature point position estimation dictionary which is used for estimating the feature point position and which is stored in the feature point position estimation dictionary storing means 210.

The model parameter calculating means 130 finds a search parameter, which is used for searching the feature point position, on the basis of the feature point estimation position which is estimated by the feature point estimation position estimating means 120. The search parameter will be explained in detail in a specific exemplary embodiment which will be described later. The feature point position searching means 140 searches the feature point position to detect a feature point position 310 by carrying out parameter fitting to a model, which expresses an eye, a nose, a mouth or the like included in the image 300, on the basis that the search parameter, which is found by the model parameter calculating means 130, is used as the initial value.

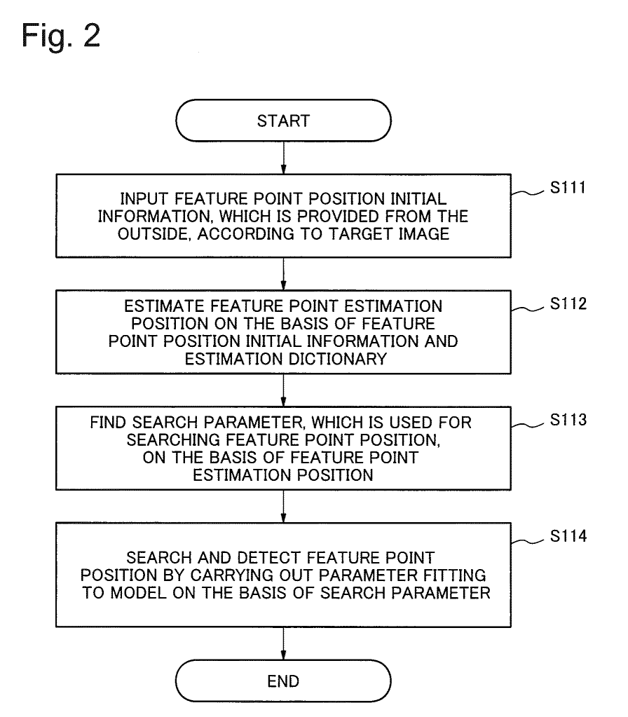

Next, an operation of the feature point position detecting apparatus 1 will be explained with reference to a drawing. FIG. 2 is a flowchart showing the operation of the feature point position detecting apparatus 1 shown in FIG. 1.

Firstly, the feature point position initial information inputting means 110 inputs the initial information on the feature point position, which is provided from the outside, according to the image 300 such as the face image or the like (Step S111). Next, the feature point estimation position estimating means 120 estimates the feature point estimation positions, whose number is requested, in the target image 300 on the basis of the initial information on the feature point position, which is inputted in Step S111, with reference to the dictionary which is used for estimating the feature point position and which is stored in the feature point position estimation dictionary storing means 210 (Step S112).

Next, the model parameter calculating means 130 finds the search parameter, which is used for searching the feature point position, on the basis of the feature point estimation position which is estimated in Step S112 (Step S113). Next, the feature point position searching means 140 searches the feature point position to detect the feature point position 310 by carrying out parameter fitting to the model on the basis that the search parameter, which is found in Step S113, is used as the initial value (Step S114).

According to the present exemplary embodiment, it is possible to search the feature point position on the basis that the appropriate initial value of the model parameter, which is found from the initial information on the feature point position inputted by the feature point position initial information inputting means 110, that is, the model parameter which approaches further to a correct solution is used by the feature point position searching means 140 as the initial value. By carrying out the above, it is possible to prevent detection of the feature point position from falling into the local optimum solution, and consequently it is possible to detect the feature point position with high level accuracy.

Next, the configuration and the operation of the present exemplary embodiment will be explained in further detail.

The storage apparatus 200 of the feature point position detecting apparatus 1 of the present exemplary embodiment shown in FIG. 1 is implemented, for example, by a semiconductor memory or a hard disk. Each of the feature point position initial information inputting means 110, the feature point estimation position estimating means 120, the model parameter calculating means 130 and the feature point position searching means 140 is implemented, for example, by CPU (Central Processing Unit) which executes a process according to program control. The feature point position estimation dictionary storing means 210 is implemented, for example, by a semiconductor memory or a hard disk.

The feature point position initial information inputting means 110 inputs the initial information on the feature point position, which is provided from the outside, into the feature point estimation position estimating means 120 according to the image 300. To inputting the initial information according to the image 300 can be realized, for example, by specifying a person, who is related to an image such as a face image or the like, in advance. The initial information on the feature point position indicates the position (coordinate) of the feature point such as an eye, a nose, a mouth or the like which can be acquired in advance, for example, by an external and optional apparatus working for detecting the feature point position.

The coordinate of the feature point position expresses the position of the feature point on the image, which is a process target of the feature point position detecting apparatus 1, as a set of two numerical values of a x coordinate value and a y coordinate value per the feature point position. It is possible to input the initial information on the feature point position, which is provided from the outside, for example, by connection with an external and optional apparatus working for detecting the feature point position, use of the art for detecting the feature point position which is described in NPL 3 or a manual operation.

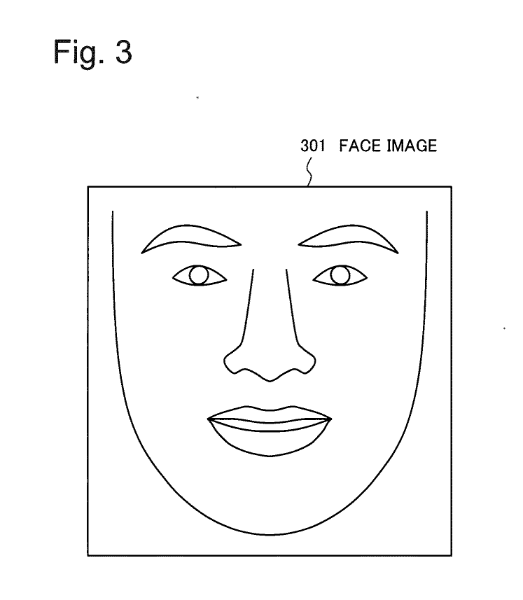

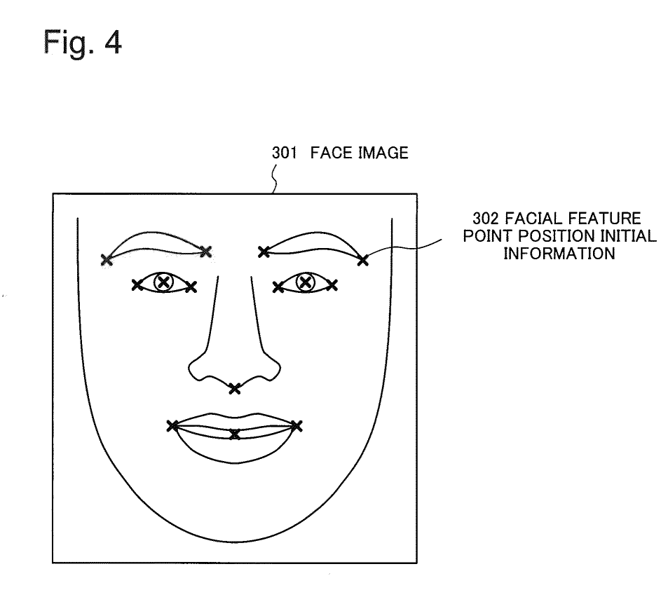

FIG. 3 is a diagram showing a face image 301 exemplifying the face image 300 which is the process target of the feature point position detecting apparatus 1, and FIG. 4 is a diagram showing that facial feature point position initial information 302, which is inputted by the feature point position information inputting means 110, is displayed on the face image 301. In FIG. 4, the facial feature point position initial information 302 which is inputted by the feature point position information inputting means 110 is displayed by use of a mark X. In this case, a total of 14 marks X are displayed at both ends of a right side eyebrow and a left side eye brow, at a center and both ends of a right side eye and a left side eye, below a nose, and at a center and both ends of a mouth.

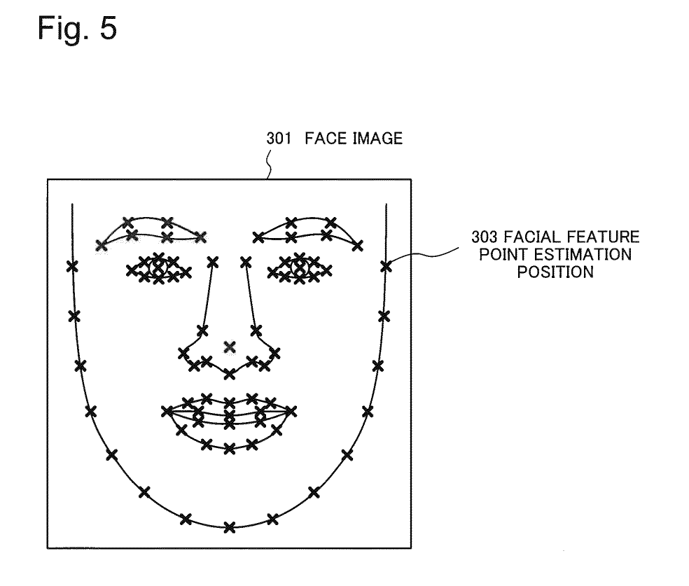

The feature point estimation position estimating means 120 estimates facial feature point estimation positions, whose number is requested, according to the face image 301, which is the target image, with reference to the dictionary, which is used for estimating the feature point position and which is stored in the feature point position estimation dictionary storing means 210, on the basis of the facial feature point position initial information 302 which is inputted by the feature point position initial information inputting means 110, that is, on the basis of the information on the coordinate values of the facial feature point position in this case. FIG. 5 shows that a facial feature point estimation position 303 is displayed on the face image 301 by use of the mark X. Estimation of the facial feature point estimation positions 303 whose number is requested can be carried out, for example, with the canonical correlation analysis method. Moreover, the requested number can be designated in each case.

Here, a case that the feature point estimation position estimating means 120 estimates coordinate values of 75 facial feature point estimation positions 303 with the canonical correlation analysis method on the basis of coordinate values of 14 pieces of the facial feature point position initial information 302, which are inputted by the feature point position information inputting means 110, will be shown in the following. The canonical correlation analysis is a method of analyzing a correlation relation among a multi-variate group. In the case that a 28-dimensional vector, which is generated by arranging the two-dimensional coordinate values of the 14 pieces of the facial feature point position initial information 302 lengthwise, is defined as a vector x, a 150-dimensional vector y, which is generated by arranging the two-dimensional coordinates values of the 75 facial feature point estimation positions 303 lengthwise, is calculated by the following formula 1.

y= [symbol] × [symbol] ×U^{T}×(x−x₀)+y₀ (Formula 1)

In the formula 1, T means to transpose a vector or a matrix.

Moreover, U, V and Λ in the formula (1) are matrices which are determined in the canonical correlation analysis. U is a matrix for finding the canonical variate of the vector x and has a size of 28×r, and V is a matrix for finding the canonical variate of the vector y and has a size of 150×r, and Λ is a matrix whose diagonal elements are the square of the canonical correlation and has a size of r×r, where r is a positive integer which is equal to or smaller than the dimensions of x and y. In this case, r is any positive integer which is equal to or smaller than 28. Furthermore, x₀ is a 28-dimensional vector which is generated by arranging mean values of the two-dimensional coordinate values of the 14 pieces of the facial feature point position initial information 302 lengthwise, and y₀ is a 150-dimensional vector which is generated by arranging mean values of the two-dimensional coordinates values of the 75 facial feature point estimation positions 303 lengthwise. Λ, U, V, x₀ and y₀ are stored in the feature point position estimation dictionary storing means 210.

The model parameter calculating means 130 finds the search parameter, which is used for searching the feature point position of the face, on the basis of the facial feature point estimation position 303 which the feature point estimation position estimating means 120 estimates. Here, a case that the feature point estimation position estimating means 120 estimates coordinate values of 75 facial feature point estimation positions 303 on the basis of coordinate values of 14 pieces of the facial feature point position initial information 302 will be shown in the following. In the case that a 150-dimensional vector, which is generated by arranging the two-dimensional coordinates values of the 75 facial feature point estimation positions 303 lengthwise, is defined as a vector y, and a model which is related to a shape of the face and which is processed by the facial feature point position searching means 140 is defined as S, and a model related to texture of the face is defined as T, and an united model of the model S related to the shape, and the model T related to the texture is defined as A, the search parameter p is calculated by the following formula 2.

p=A(S(y),T(y)) (Formula 2)

S(y) and T(y) in the formula 2 are functions whose input is y and which, according to the models S and T which are defined in advance, return the search parameters related to each model respectively, and A is a function whose inputs are S(y) and T(y) and which, according to the model A which is defined in advance, returns the search parameter. In the case of Active Appearance Model (AAM), each of the model S, the model T and the model A is defined usually as a linear subspace. When matrices generated by arranging vectors, which compose the subspaces of the models S, T and A respectively, are rewritten as matrices S, T and A respectively, the search parameter p is calculated by the following formula 3.

pₛ=S^{T}×(y−y₀)

pₜ=T^{T}×(g(y)−g₀)

p=A^{T}×(pₛ^{T},pₜ^{T})^{T} (Formula 3)

Here, matrix sizes of S, T and A are 150×rₛ, (number of dimensions of g(y)×rₜ and (rₛ+rₜ)×rₐ respectively, where rₛ, rₜ and rₐ are ranks of S, T and A respectively. In this case, sizes of pₛ, pₜ and pₐ are rₛ×1, rₜ×1, and rₐ×1 respectively. Moreover, g(y) is a function which, on the basis of the 150-dimensional vector y which is generated by arranging the two-dimensional coordinates values of the 75 facial feature point estimation positions 303 lengthwise, extracts a position and largeness of the face on the 2-dimensional image, a rotation angle on the 2-dimensional image, and a face image whose face shape is normalized. An output of the function g is a vector which is generated by arranging values of pixels of the normalized face image lengthwise. For example, in the case that a size of the normalized face image is 100 pixels×100 pixels, the output of the function g is a 10000-dimensional vector. In AAM which is described in NPT 1, the function g is known as the warp image. According to the warp image, a triangle, which is formed by any three points out of plural feature point positions, is defined, and the face image is normalized by carrying out the affine transformation per the triangle. Moreover, g₀ is an average vector of g(y) which is calculated in advance on the basis of plural face images and the feature point position information y of each face image.

By carrying out the parameter fitting to the model with using the search parameter p, which is found by the model parameter calculating means 130, as an initial value, the feature point position searching means 140 searches the feature point position to detect the feature point position. In the case of AAM, as the parameter fitting of the model, for example, the method of NPL 1 is applicable.

That is, in the case that the parameter fitting of the model is carried out in AAM with using the search parameter p as the initial value, firstly, in a first step, by using the model S, the model T and the model A which have learned in AAM in advance, a parameter Pₛ related to the shape of the face, and a parameter pₜ related to the texture of the face are found on the basis of the search parameter p and the model A. Next, in a second step, the feature point position y of the face is found by use of the parameter Pₛ related to the shape, and the model S, and afterward a normalized face image gₛ is found by gₛ=g(y+yₒ). Next, in a third step, a face image gₘ which is estimated from the search parameter p is found by use of the pₜ related to the texture, and the model T. Furthermore, in a fourth step, a differential image d is calculated by d=gₛ−gₘ, and an increment δp for updating the search parameter is found by δp=−R×d, and then the search parameter p is updated by p=p+δp, where R is a matrix which has learned in AAM in advance. By repeating the first step to the fourth step plural times, it is possible to fix the feature point position of the face image 301.

By inputting the initial information on the feature point positions, whose number is small, from the outside, it is possible to estimate a position near to a requested feature point position against the change in the face expression of the face image, the personal face difference, the change in the posture or the like, and it is possible to start searching the feature point position from the position near to the requested feature point position. By virtue of the above, it is restrained to fit a shape of the face such as the posture or the face expression, which is different from the correct solution, to the input image erroneously. That is, to fall into the local optimum solution is prevented.

That is, it is possible to search the feature point position on the basis that the appropriate initial value of the model parameter, which is found from the initial information on the feature point position inputted by the feature point position initial information inputting means 110, that is, the model parameter which approaches further to a correct solution is used by the feature point position searching means 140 as the initial value. By carrying out the above, it is possible to detect the feature point position with high level accuracy against the change in the face expression of the face image, the personal face difference, the change in the posture or the like.

The present invention not only makes it possible to specify the feature point position of the face image with high level accuracy, but also makes it possible to specify the feature point position of any kinds of images with high level accuracy. For example, another means detects initial information on a thumb, a forefinger, a nail or the like, which is corresponding to a feature point position of a hand in place of the feature point position of the face, in advance, and the feature point position initial information inputting means 110 inputs the initial information. As a result, it is possible to detect an outline of the finger, the nail or the like.

Moreover, it is possible to specify an outline of a bone, an internal organ or the like in a medical image. Specifically, another means detects initial information on a bone or an internal organ, which is predetermined, as the feature point position in advance, and the feature point position initial information inputting means 110 inputs the initial information. As a result, it is possible to detect the bone or the internal organ which is predetermined. Similarly, it is also possible to specify a skin pattern of a domestic animal such as a black and white skin pattern of a cattle or the like.

Furthermore, since it is possible to detect the feature point position with high level accuracy according to the present exemplary embodiment, by using the present exemplary embodiment, it is also possible to specify kinds of animals and plants, and to specify kinds of cars, ships, aircrafts, electronic equipment, buildings, pictures or the like as an artifact. For example, in the case of a car, another means detects initial information on a head light, which is corresponding to a feature point position of a predetermined kind of car, in advance, and the feature point position initial information inputting means 110 inputs the initial information. As a result, it is possible to detect the headlight of the predetermined car, and consequently it is also possible to specify the kind of car. The above mention is applicable to the animal, the plant and another artifact.

The present invention is not limited to the above-mentioned exemplary embodiments. It is possible to make various modifications within the scope of the invention which are described in Claims, and apparently these modifications are included in the scope of the present invention.

A part of or a whole of the above-mentioned exemplary embodiments can be described as shown in the following supplementary notes, but the present invention is not limited to the following supplementary notes.

(Supplementary Note)

(Supplementary Note 1)

A feature point position detecting apparatus, comprising:
a feature point position initial information inputting means to input initial information on a position of a feature point, which is provided from the outside, according to a target image;
a feature point estimation position estimating means to estimate feature point estimation positions, whose number is requested, in the target image on the basis of the feature point position initial information and feature point position estimation dictionary information;
a model parameter calculating means to find a search parameter, which is used for searching the feature point position of the target image, on the basis of the feature point estimation position; and
a feature point position searching means to search and detect the feature point position of the target image by carrying out parameter fitting to a model of the target image on the basis of the search parameter.

(Supplementary Note 2)

The feature point position detecting apparatus, according to supplementary note 1, wherein
number of the feature point estimation positions is larger than number of pieces of the feature point position initial information.

(Supplementary Note 3)

The feature point position detecting apparatus, according to supplementary note 1 or 2, comprising:
a feature point position estimation dictionary storing means to store the feature point position estimation dictionary information.

(Supplementary Note 4)

The feature point position detecting apparatus, according to any one of supplementary notes 1 to 3, wherein
the target image includes an image of a human body.

(Supplementary Note 5)

The feature point position detecting apparatus, according to supplementary note 4, wherein
the feature point position of the human body includes information on an eye, a nose or a mouth of a face.

(Supplementary Note 6)

A feature point position detecting method, comprising:
inputting initial information on a position of a feature point, which is provided from the outside, according to a target image;
estimating feature point estimation positions, whose number is requested, in the target image on the basis of the feature point position initial information and feature point position estimation dictionary information;
finding a search parameter, which is used for searching the feature point position of the target image, on the basis of the feature point estimation position; and
searching and detecting the feature point position of the target image by carrying out parameter fitting to a model of the target image on the basis of the search parameter.

(Supplementary Note 7)

The feature point position detecting method, according to supplementary note 6, wherein
number of the feature point estimation positions is larger than number of pieces of the feature point position initial information.

(Supplementary Note 8)

The feature point position detecting method, according to supplementary note 6 or 7, wherein:
the feature point position estimation dictionary information is acquired by using a stored feature point position estimation dictionary.

(Supplementary Note 9)

The feature point position detecting method, according to any one of supplementary notes 6 to 8, wherein
the target image includes an image of a human body.

(Supplementary Note 10)

The feature point position detecting method, according to supplementary note 9, wherein
the feature point position of the human body includes information on an eye, a nose or a mouth of a face.

(Supplementary Note 11)

A feature point position detecting program which makes a feature point position detecting apparatus execute:
a process of inputting initial information on a position of a feature point, which is provided from the outside, according to a target image;
a process of estimating feature point estimation positions, whose number is requested, in the target image on the basis of the feature point position initial information and feature point position estimation dictionary information;
a process of finding a search parameter, which is used for searching the feature point position of the target image, on the basis of the feature point estimation position; and
a process of searching and detecting the feature point position of the target image by carrying out parameter fitting to a model of the target image on the basis of the search parameter.

(Supplementary Note 12)

The feature point position detecting program according to supplementary note 11, wherein
number of the feature point estimation positions is larger than number of pieces of the feature point position initial information.

(Supplementary Note 13)

The feature point position detecting program according to supplementary note 11 or 12, wherein
the feature point position estimation dictionary information is acquired by using a stored feature point position estimation dictionary.

(Supplementary Note 14)

The feature point position detecting program, according to any one of supplementary notes 11 to 13, wherein
the target image includes an image of a human body.

(Supplementary Note 15)

The feature point position detecting program, according to supplementary note 14, wherein
the feature point position of the human body includes information on an eye, a nose or a mouth of a face.

(Supplementary Note 16)

A feature point position detecting apparatus, comprising:
a feature point position initial information inputting means to input initial information on a position of a feature point, which is provided from the outside, according to a target image;
a feature point estimation position estimating means to estimate feature point estimation positions, whose number is requested, in the target image on the basis of the feature point position initial information and feature point position estimation dictionary information; and
a feature point position searching means to start searching the feature point position from the feature point estimation positions whose number is requested.

(Supplementary Note 17)

A feature point position detecting method, comprising:
inputting initial information on a position of a feature point, which is provided from the outside, according to a target image;
estimating feature point estimation positions, whose number is requested, in the target image on the basis of the feature point position initial information and feature point position estimation dictionary information; and
starting searching the feature point position from the feature point estimation positions whose number is requested.

(Supplementary Note 18)

A feature point position detecting program which makes a feature point position detecting apparatus execute:
a process of inputting initial information on a position of a feature point, which is provided from the outside, according to a target image;
a process of estimating feature point estimation positions, whose number is requested, in the target image on the basis of the feature point position initial information and feature point position estimation dictionary information; and
a process of starting searching the feature point position from the feature point estimation positions whose number is requested.

This application is based upon and claims the benefit of priority from Japanese Patent Application No. 2013-004228, filed on Jan. 15, 2013, the disclosure of which is incorporated herein in its entirety by reference.

### INDUSTRIAL APPLICABILITY

The present invention relates to the feature point position detecting art for detecting the position of the feature point such as an eye, a nose or the like of a face on the basis of the face image or the like, and is used for the face authentication and the facial expression recognition.

### REFERENCE SIGNS LIST

1 feature point position detecting apparatus
100 data processing apparatus
110 feature point position initial information inputting means
120 feature point estimation position estimating means
130 model parameter calculating means
140 feature point position searching means
200 storage apparatus
210 feature point position estimation dictionary storing means
300 image
301 face image
302 facial feature point position initial information
303 facial feature point estimation position
310 facial feature point position

What is claimed is:

1. A feature point position detecting apparatus, comprising:
a feature point position initial information inputting unit to input initial information on a position of a feature point, which is provided from the outside, according to a target image;
a feature point estimation position estimating unit to estimate feature point estimation positions, whose number is requested, in the target image on the basis of the feature point position initial information and feature point position estimation dictionary information;
a model parameter calculating unit to find a search parameter, which is used for searching the feature point position of the target image, on the basis of the feature point estimation position; and
a feature point position searching unit to search and detect the feature point position of the target image by carrying out parameter fitting to a model of the target image on the basis of the search parameter.

2. The feature point position detecting apparatus, according to claim 1, wherein
number of the feature point estimation positions is larger than number of pieces of the feature point position initial information.

3. The feature point position detecting apparatus, according to claim 1, comprising:
a feature point position estimation dictionary storing unit to store the feature point position estimation dictionary information.

4. The feature point position detecting apparatus, according to claim 1, wherein
the target image includes an image of a human body.

5. The feature point position detecting apparatus, according to claim 4, wherein
the feature point position of the human body includes information on an eye, a nose or a mouth of a face.

6. A feature point position detecting method, comprising:
inputting initial information on a position of a feature point, which is provided from the outside, according to a target image;
estimating feature point estimation positions, whose number is requested, in the target image on the basis of the feature point position initial information and feature point position estimation dictionary information;
finding a search parameter, which is used for searching the feature point position of the target image, on the basis of the feature point estimation position; and
searching and detecting the feature point position of the target image by carrying out parameter fitting to a model of the target image on the basis of the search parameter.

7. The feature point position detecting method according to claim 6, wherein
number of the feature point estimation positions is larger than number of pieces of the feature point position initial information.

8. The feature point position detecting method, according to claim 6, wherein:
the feature point position estimation dictionary information is acquired by using a stored feature point position estimation dictionary.

9. A computer readable medium embodying a feature point position detecting program which makes a feature point position detecting apparatus execute:
a process of inputting initial information on a position of a feature point, which is provided from the outside, according to a target image;
a process of estimating feature point estimation positions, whose number is requested, in the target image on the basis of the feature point position initial information and feature point position estimation dictionary information;
a process of finding a search parameter, which is used for searching the feature point position of the target image, on the basis of the feature point estimation position; and
a process of searching and detecting the feature point position of the target image by carrying out parameter fitting to a model of the target image on the basis of the search parameter.

10. The computer readable medium embodying the feature point position detecting program, according to claim 9, wherein
number of the feature point estimation positions is larger than number of pieces of the feature point position initial information.

11. (canceled)

12. (canceled)

13. (canceled)
